(19) United States
(12) Patent Application Publication
(10) Pub. No.: US 2009/0216608 A1
(43) Pub. Date: Aug. 27, 2009

(54) COLLABORATIVE REVIEW SYSTEM

(75) Inventor: Michael E. Bechtel, Naperville, IL (US)

Correspondence Address: ACCENTURE CHICAGO 28164;BRINKS HOFER GILSON & LIONE, P O BOX 10395, CHICAGO, IL, 60610, US

(73) Assignee: ACCENTURE GLOBAL SERVICES GMBH, Schaffhausen (CH)

(21) Appl. No.: 12/036,001

(22) Filed: Feb. 22, 2008

(51) Int. Cl. G06Q 10/00; G06F 17/00

(52) U.S. Cl. 705/10; 705/7

(57) ABSTRACT

A system for collaborative review is described. The system may include a memory, an interface, and a processor. The memory may store responses, an item, ratings, user response quality scores, weighted ratings, and total ratings. The interface may communicate with users and a content provider. The processor may receive the item from the content provider. The processor may receive the responses, based on the item, from the users. The processor may receive the ratings for each response from the users. The processor may calculate the user response quality score for each user and may determine the weighted rating of each response based on the user quality score of the user who provided the response. The processor may determine the total rating for each response based on the weighted ratings and may provide the responses, ordered based on the total ratings, to the content provider.

### TECHNICAL FIELD

The present description relates generally to a system and method, generally referred to as a system, for providing for collaborative review, and more particularly, but not exclusively, to providing for collaborative review where users' ratings are weighted based on the quality of the users' participation in the system.

### BACKGROUND

Collaborative systems may allow users to cooperatively build off an initial topic by structuring and restructuring the topic. The initial topic may continually evolve as additional users provide insight to the topic. The final result may be a representation of the group knowledge over a period of time. However, collaborative review systems may assume that the insight and knowledge of all the users is equal. Collaborative review systems may be unable to properly account for users of varying knowledge and expertise on a given topic.

### SUMMARY

A system for collaborative review may include a memory, an interface, and a processor. The memory may be connected to the processor and the interface and may store a plurality of responses, an item, a plurality of ratings, a plurality of user response quality scores, a plurality of weighted ratings and a plurality of total ratings. The interface may communicate with a plurality of users and a content provider. The processor may receive the item from the content provider via the interface. The processor may receive the plurality of responses based on the item from the plurality of users via the interface. The processor may receive the plurality of ratings for each response from the users via the interface. The processor may calculate the user response quality score for each user and may determine the weighted rating of each response based on the user quality score of the user who provided the response. The processor may determine the total rating for each response based on the weighted ratings of each response and may provide the responses, ordered based on the total rating of each response, to the content provider.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The system and/or method may be better understood with reference to the following drawings and description. Non-limiting and non-exhaustive descriptions are described with reference to the following drawings. The components in the figures are not necessarily to scale, emphasis instead being placed upon illustrating principles. In the figures, like referenced numerals may refer to like parts throughout the different figures unless otherwise specified.

FIG. 1 is a block diagram of a general overview of a collaborative review system.

FIG. 2 is a block diagram of a network environment implementing the system of FIG. 1 or other collaborative review systems.

FIG. 3 is a block diagram of the server-side components in the system of FIG. 1 or other collaborative review systems.

FIG. 4 is a flowchart illustrating the operations of the system of FIG. 1, or other collaborative review systems.

FIG. 5 is a flowchart illustrating the operations of calculating a user response quality score in the system of FIG. 1, or other collaborative review systems.

FIG. 6 is a flowchart illustrating the operations of maintaining a user response quality score in the system of FIG. 1, or other collaborative review systems.

FIG. 7 is an illustration of a general computer system that may be used in the systems of FIG. 2 or FIG. 3, or other collaborative review systems.

### DETAILED DESCRIPTION

A system and method, generally referred to as a system, may relate to providing for collaborative review, and more particularly, but not exclusively, providing for collaborative review where users' reviews are weighted based on the quality of the users' participation in the system. The principles described herein may be embodied in many different forms.

The system may be used in a collaborative environment to increase the accuracy of the collaborative results. For example, in a collaborative environment users may be presented with an initial item, such as a question, for review. A user may provide a response to the initial item and may rate the responses of other users. The ratings of the users may be used to determine which response is the most accurate response to the initial item. The system may increase the accuracy determining the most accurate response by weighting the ratings of each user. The weight may be indicative of the user's proficiency in the collaborative environment. The weight for each user may be based on the user's activity in the collaborative environment and the ratings the user's responses have received from the other users in the collaborative environment. Thus, when determining the most accurate response the weight applied to the ratings of an expert user may be higher than the weight applied to the ratings of a novice user. By applying more weight to the ratings of the expert users and less weight to the rating of the novice users, the system may increase the accuracy of the collaborative results.

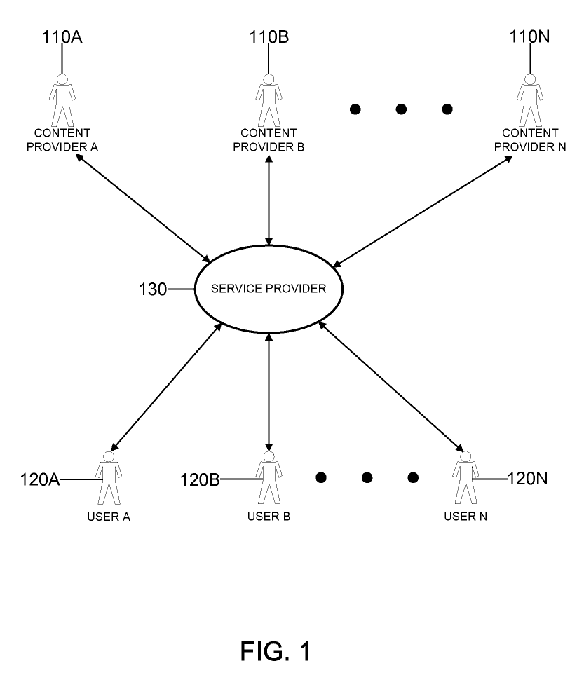

FIG. 1 provides a general overview of a collaborative review system 100. Not all of the depicted components may be required, however, and some implementations may include additional components. Variations in the arrangement and type of the components may be made without departing from the spirit or scope of the claims as set forth herein. Additional, different or fewer components may be provided.

The system 100 may include one or more content providers 110A-N, such as any providers of content for review, a service provider 130, such as a collaborative review service provider, and one or more users 120A-N, such as any users in a collaborative environment. For example, in an organization the content providers 110A-N may be upper management, or decision makers within the organization while the users 120A-N may be employees of the organization. In another example, the content providers 110A-N may be administrators of an online collaborative web site, such as WIKIPEDIA, and the users 120A-N may be any web surfers providing knowledge to the collaborative website. Alternatively or in addition the users 120A-N may be the content providers 110A-N and vice-versa.

The initial item may be any content capable of being responded to by the users 120A-N, such as a statement, a question, a news article, an image, an audio clip, a video clip, or generally any content. In the example of an organization, a content provider A 110A may provide a question as the initial item, such as a question whose answer is of importance to the upper management of the organization.

The users 120A-N may provide responses to the initial item, such as comments, or generally any information that may assist the collaborative review process. The users 120A-N may also provide ratings of the responses of the other users 120A-N. The ratings may be indicative of whether the users 120A-N believe the response is accurate for the initial item. For example, if the initial item is a question the users 120A-N may rate the responses based on which response they believe is the most accurate response to the question. The service provider 130 may order the responses based on the ratings the responses receive, and may provide the ordered responses to the content provider A 110A who provided the initial item. The content provider A 110A may be able quickly review the highest rated responses and select the response which the content provider A 110A believes is the most accurate. The content provider A 110A may provide an indication of their selection of the most accurate response to the service provider 130.

The service provider 130 may maintain a user response quality score for each of the users 120A-N in the system 100. The user response quality score may be indicative of the level of proficiency of the users 120A-N in the system 100. The user response quality score for the user A 120A may be based on the number of responses the user A 120A has contributed to the system 100, the number of times the responses of the user A 120A have been viewed by the other users 120B-N, the average rating the users 120B-N have given the responses of the user A 120A, and the number of responses of the user A 120A has been selected as the most accurate response by one of the content providers 110A-N.

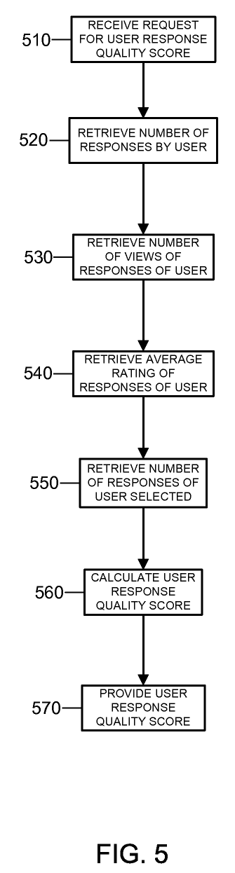

The user response quality score may be normalized across all of the users 120A-N. For example, if the user response quality score is based on the number of responses provided by the user A 120A, the service provider 130 may divide the number of responses provided by the user A 120A by the average number of responses provided by each of the users 120A-N to determine the user response quality score of the user A 120A. The service provider 130 may use the user response quality score as a weight in determining the total ratings of the responses by multiplying the user response quality score by each rating provided by the user A 120A. The calculation of the user response quality score of each of the users 120A-N may be discussed in more detail in FIG. 5.

For example, if the service provider 130 requests the users 120A-N to rate whether the “like” or “don't like” a response, a “like” rating may correlate to a value of 1 and a “don't like” rating may correlate to a value of 0. The rating given by each of the users 120A-N may be multiplied by the normalized user response quality score of each of the users 120A-N to determine the weighted rating of each user. The weighted rating of each of the users 120A-N for a given response may then be added together to generate a total rating for the response. By multiplying the ratings of the users 120A-N by a normalized weight, the ratings of the more proficient users 120A-N may be granted a greater affect than those of the less proficient users 120A-N.

The content providers 110A-N may provide incentives, such as rewards, to the users 120A-N, such as the user A 120A, if the user quality score of the user A 120A is above a certain threshold. The rewards may motivate the users 120A-N to participate in the system 100 and provide accurate responses to the system 100. Alternatively or in addition, the content providers 110A-N may eliminate a user A 120A from the system 100 if the user quality score of the user A 120A falls below a certain threshold. In the example of an organization, being eliminated from the system 100 may be detrimental to the employment of a user A 120A, so the user A 120A may also be motivated to not fall below the threshold. By properly incentivizing the users 120A-N, the content providers 110A-N may increase the accuracy of the collaborative review.

In operation one of the content providers 110A-N, such as the content provider A 110A may provide an item for review. The item may be a question whose answer is of value to the content provider A 110A. The content provider A 110A may identify a period of time that the question should be provided to the users 120A-N for review. The content provider A 110A may also identify a set of the users 120A-N that the question should be provided to. The content provider A 110A may use the user quality score of the users 120A-N as a threshold for users 120A-N to be included in the review. For example, the content provider A 110A may specify that only the users 120A-N with user quality scores in the top ten percent should be provided the item for review. The content provider A 110A may also select a set of the users 120A-N based on the demographics of the users 120A-N, or generally any characteristic of the users 120A-N capable of segmenting the users 120A-N. The users 120A-N may be required to provide demographic information when they first register for the system 100. In the case of an organization the human resources department of the organization may provide the demographic information of the users 120A-N.

The service provider 130 may provide the item to the users 120A-N for review. The users 120A-N may be notified that the item is available, such as via an email notification. The users 120A-N may provide one or more responses to the item. In the case of a question, the users 120A-N may provide one or more answers to the question. The service provider 130 may receive the responses from the users 120A-N, and may provide the responses to the other users 120A-N. The users 120A-N may rate the responses.

Once the review period indicated by the content provider A 110A has expired, the service provider 130 may stop providing the item to the users 120A-N. The service provider 130 may then calculate a total rating for each response received from the users 120A-N. The total rating for a response may be a sum of each of the weighted ratings the response received from the users 120A-N. A weighted rating may be equal to the value of the rating received from a user A 120A multiplied by the user response quality score of the user A 120A. The service provider 130 may order the responses based on the total rating of each response. The service provider 130 may provide the ordered list of responses to the content provider A 110A who provided the initial item. The ordered list of responses may allow the content provider A 110A to quickly and efficiently determine the most accurate response. The content provider A 110A may select one or more response as the most accurate response or responses. The content provider A 110A may provide an indication of the selection of the most accurate response or responses to the service provider 130.

At set intervals of time, such every 3 months, the service provider 130 may determine which of the users 120A-N achieved a user quality score above the incentive threshold. The users 120A-N with a user quality score above the threshold may be offered a reward. Alternatively or in addition the service provider 130 may award the users 120A-N immediately when their user quality score reaches the incentive threshold.

The service provider 130 may provide one or more reports to the content providers 110A-N and/or the users 120A-N indicating the activity of the users 120A-N and/or the content providers 110A-N, such as displaying the user response quality scores of the users 120A-N. The reports may also provide information about the items rated by the system 100 and the selected response for each initial item.

One or more of the users 120A-N and/or the content providers 110A-N may be an administrator of the system 100. An administrator may be generally responsible for maintaining the system 100 and may be responsible for maintaining the permissions of the users 120A-N and the content providers 110A-N. The administrator may need to approve of any new users 120A-N in the system 100 before the users 120A-N are allowed to provide responses and ratings to the system 100.

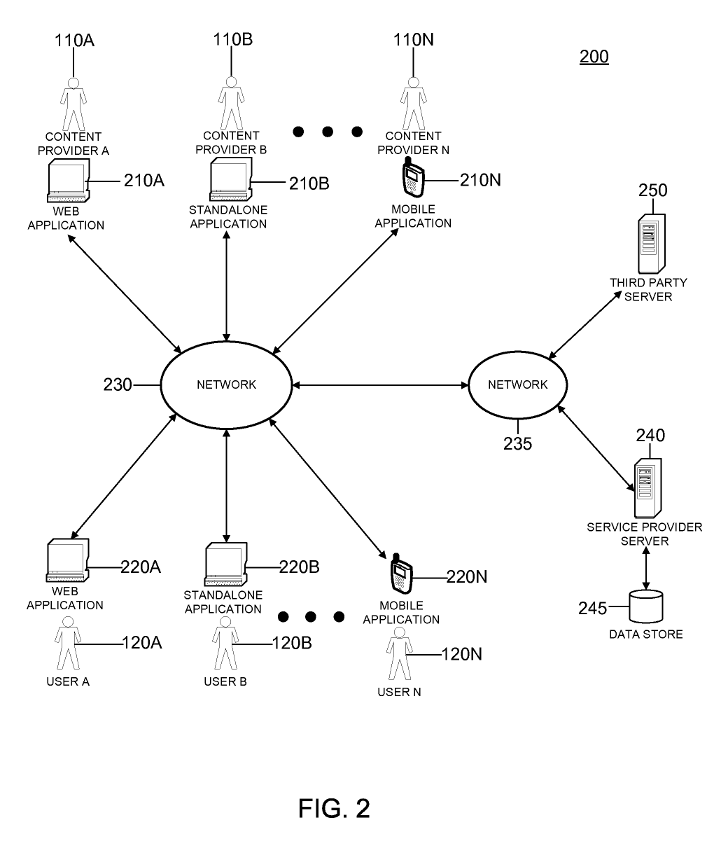

FIG. 2 provides a view of a network environment 200 implementing the system of FIG. 1 or other collaborative review systems. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 200 may include one or more web applications, standalone applications and mobile applications 210A-N, which may be client applications of the content providers 110A-N. The system 200 may also include one or more web applications, standalone applications, mobile applications 220A-N, which may be client applications of the users 120A-N. The web applications, standalone applications and mobile applications 210A-N, 220A-N, may collectively be referred to as client applications 210A-N, 220A-N. The system 200 may also include a network 230, a network 235, the service provider server 240, a data store 245, and a third party server 250.

Some or all of the service provider server 240 and third-party server 250 may be in communication with each other by way of network 235. The third-party server 250 and service provider server 240 may each represent multiple linked computing devices. Multiple distinct third party servers, such as the third-party server 250, may be included in the network environment 200. A portion or all of the third-party server 250 may be a part of the service provider server 240.

The data store 245 may be operative to store data, such as user information, initial items, responses from the users 120A-N, ratings by the users 120A-N, user response quality scores, or generally any data that may need to be stored in a data store 245. The data store 245 may include one or more relational databases or other data stores that may be managed using various known database management techniques, such as SQL and object-based techniques. Alternatively or in addition the data store 245 may be implemented using one or more of the magnetic, optical, solid state or tape drives. The data store 245 may be in direct communication with the service provider server 240. Alternatively or in addition the data store 245 may be in communication with the service provider server 240 through the network 235.

The networks 230, 235 may include wide area networks (WAN), such as the internet, local area networks (LAN), campus area networks, metropolitan area networks, or any other networks that may allow for data communication. The network 230 may include the Internet and may include all or part of network 235; network 235 may include all or part of network 230. The networks 230, 235 may be divided into sub-networks. The sub-networks may allow access to all of the other components connected to the networks 230, 235 in the system 200, or the sub-networks may restrict access between the components connected to the networks 230, 235. The network 235 may be regarded as a public or private network connection and may include, for example, a virtual private network or an encryption or other security mechanism employed over the public Internet.

The content providers 110A-N may use a web application 210A, standalone application 210B, or a mobile application 210N, or any combination thereof, to communicate to the service provider server 240, such as via the networks 230, 235. Similarly, the users 120A-N may use a web application 220A, a standalone application 220B, or a mobile application 220N to communicate to the service provider server 240, via the networks 230, 235.

The service provider server 240 may provide user interfaces to the content providers 110A-N via the networks 230, 235. The user interfaces of the content providers 110A-N may be accessible through the web applications, standalone applications or mobile applications 210A-N. The service provider server 240 may also provide user interfaces to the users 120A-N via the networks 230, 235. The user interfaces of the users 120A-N may also be accessible through the web applications, standalone applications or mobile applications 220A-N. The user interfaces may be designed using ADOBE FLEX. The user interfaces may be initially downloaded when the applications 210A-N, 220A-N first communicate with the service provider server 240. The client applications 210A-N, 220A-N may download all of the code necessary to implement the user interfaces, but none of the actual data. The data may be downloaded from the service provider server 240 as needed. The user interfaces may be developed using the singleton development pattern, utilizing the model locator found within the cairngorm framework. Within the singleton pattern there may be several data structures each with a corresponding data access object. The data structures may be structured to receive the information from the service provider server 240.

The user interfaces of the content providers 110A-N may be operative to allow a content provider A 110A to provide an initial item, and allow the content provider A 110A to specify a period of time for review of the item. The user interfaces of the users 120A-N may be operative to display the initial item to the users 120A-N, allow the users 120A-N to provide responses and ratings, and display the responses and ratings to the other users 120A-N. The user interfaces of the content providers 110A-N may be further operative to display the ordered list of responses to the content provider A 110A and allow the content provider to provide an indication of the selected response.

The web applications, standalone applications and mobile applications 210A-N, 220A-N may be connected to the network 230 in any configuration that supports data transfer. This may include a data connection to the network 230 that may be wired or wireless. The web applications 210A, 220A may run on any platform that supports web content, such as a web browser or a computer, a mobile phone, personal digital assistant (PDA), pager, network-enabled television, digital video recorder, such as TIVO®, automobile and/or any appliance capable of data communications.

The standalone applications 210B, 220B may run on a machine that may have a processor, memory, a display, a user interface and a communication interface. The processor may be operatively connected to the memory, display and the interfaces and may perform tasks at the request of the standalone applications 210B, 220B or the underlying operating system. The memory may be capable of storing data. The display may be operatively connected to the memory and the processor and may be capable of displaying information to the content provider B 110B or the user B 120B. The user interface may be operatively connected to the memory, the processor, and the display and may be capable of interacting with a user B 120B or a content provider B 110B. The communication interface may be operatively connected to the memory, and the processor, and may be capable of communicating through the networks 230, 235 with the service provider server 240, and the third party server 250. The standalone applications 210B, 220B may be programmed in any programming language that supports communication protocols. These languages may include: SUN JAVA®, C++, C#, ASP, SUN JAVASCRIPT®, asynchronous SUN JAVASCRIPT®, or ADOBE FLASH ACTIONSCRIPT®, ADOBE FLEX, and PHP, amongst others.

The mobile applications 210N, 220N may run on any mobile device that may have a data connection. The data connection may be a cellular connection, a wireless data connection, an internet connection, an infra-red connection, a Bluetooth connection, or any other connection capable of transmitting data.

The service provider server 240 may include one or more of the following: an application server, a data store, such as the data store 245, a database server, and a middleware server. The application server may be a dynamic HTML server, such as using ASP, JSP, PHP, or other technologies. The service provider server 240 may co-exist on one machine or may be running in a distributed configuration on one or more machines. The service provider server 240 may collectively be referred to as the server. The service provider server 240 may implement a server side Wiki engine, such as ATLASSIAN CONFLUENCE. The service provider server 240 may receive requests from the users 120A-N and the content providers 110A-N and may provide data to the users 120A-N and the content providers 110A-N based on their requests. The service provider server 240 may communicate with the client applications 210A-N, 220A-N using extensible markup language (XML) messages.

The third party server 250 may include one or more of the following: an application server, a data source, such as a database server, and a middleware server. The third party server may implement any third party application that may be used in a collaborative review system, such as a user verification system. The third party server 250 may co-exist on one machine or may be running in a distributed configuration on one or more machines. The third party server 250 may receive requests from the users 120A-N and the content providers 110A-N and may provide data to the users 120A-N and the content providers 110A-N based on their requests.

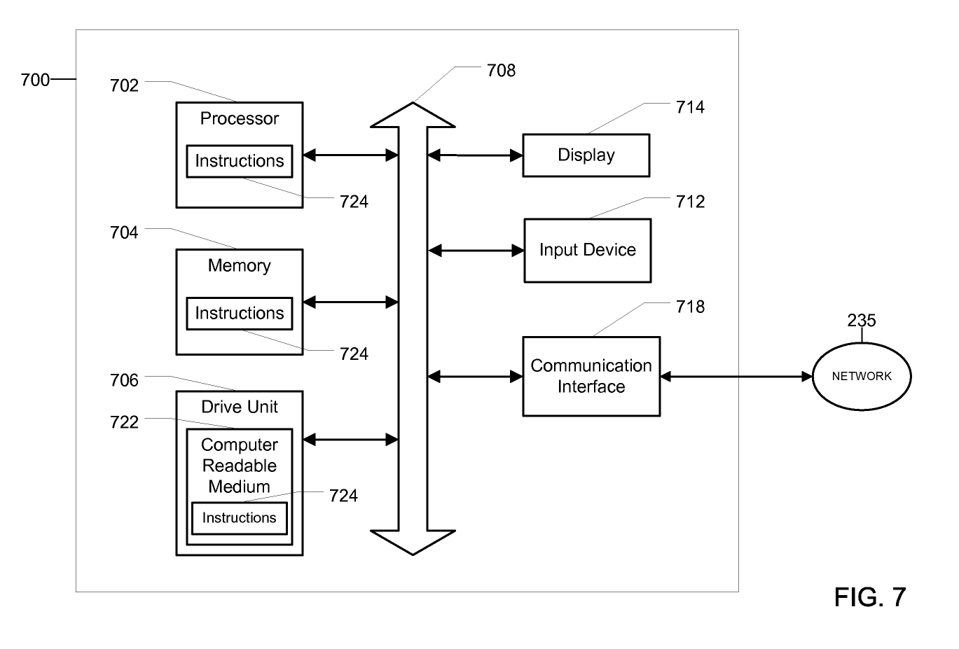

The service provider server 240 and the third party server 250 may be one or more computing devices of various kinds, such as the computing device in FIG. 7. Such computing devices may generally include any device that may be configured to perform computation and that may be capable of sending and receiving data communications by way of one or more wired and/or wireless communication interfaces. Such devices may be configured to communicate in accordance with any of a variety of network protocols, including but not limited to protocols within the Transmission Control Protocol/Internet Protocol (TCP/IP) protocol suite. For example, the web applications 210A, 210A may employ HTTP to request information, such as a web page, from a web server, which may be a process executing on the service provider server 240 or the third-party server 250.

There may be several configurations of database servers, such as the data store 245, application servers, and middleware servers included in the service provider server 240, or the third party server 250. Database servers may include MICROSOFT SQL SERVER®, ORACLE®, IBM DB2® or any other database software, relational or otherwise. The application server may be APACHE TOMCAT®, MICROSOFT IIS®, ADOBE COLDFUSION®, or any other application server that supports communication protocols. The middleware server may be any middleware that connects software components or applications.

The networks 230, 235 may be configured to couple one computing device to another computing device to enable communication of data between the devices. The networks 230, 235 may generally be enabled to employ any form of machine-readable media for communicating information from one device to another. Each of networks 230, 235 may include one or more of a wireless network, a wired network, a local area network (LAN), a wide area network (WAN), a direct connection such as through a Universal Serial Bus (USB) port, and the like, and may include the set of interconnected networks that make up the Internet. The networks 230, 235 may include any communication method by which information may travel between computing devices.

In operation the client applications 210A-N, 220A-N may make requests back to the service provider server 240. The service provider server 240 may access the data store 245 and retrieve information in accordance with the request. The information may be formatted as XML and communicated to the client applications 210A-N, 220A-N. The client applications 210A-N, 220A-N may display the XML appropriately to the users 120A-N, and/or the content providers 110A-N.

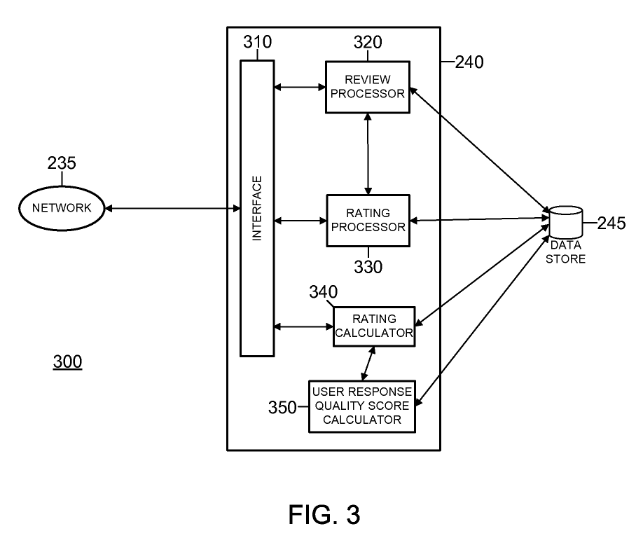

FIG. 3 provides a view of the server-side components in a network environment 300 implementing the system of FIG. 1 or other collaborative review systems. Not all of the depicted components may be required, however, and some implementations may include additional components not shown in the figure. Variations in the arrangement and type of the components may be made without departing from the spirit or scope of the claims as set forth herein. Additional, different or fewer components may be provided.

The network environment 300 may include the network 235, the service provider server 240, and the data store 245. The server provider server 240 may include an interface 310, a response processor 320, a rating processor 330, rating calculator 340, and a user quality score calculator 350. The interface 310, response processor 320, rating processor 330, rating calculator 340, and the user quality score calculator 350 may be processes running on the service provider server 240, may be hardware components of the service provider server 240, or may be separate computing devices, such as the one described in FIG. 7.

The interface 310 may communicate with the users 120A-N and the content providers 110A-N via the networks 230, 235. The response processor 320 may process responses and initial items from the users 120A-N and the content providers 110A-N, the rating processor 330 may process ratings received from the users 120A-N, views of responses of the users 120A-N, and selections of the content provider A 110A, the rating calculator 340 may calculate the weighted ratings and total ratings of the responses, and the user response quality score calculator 350 may calculate the user response quality scores of the users 120A-N.

In operation the interface 310 may receive data from the content providers 110A-N or the users 120A-N via the network 235. For example, one of the content providers 110A-N, such as the content provider A 110A, may provide an initial item, and one of the users 120A-N, such as the user A 120A may provide a response or a rating of a response. In the case of an initial item received from the content provider A 110A, the interface 310 may communicate the initial item to the response processor 320. The response processor 320 may store the initial item in the data store 245. The response processor 320 may store data describing the content provider A 110A who provided the initial item and the date/time the initial item was provided. The response processor 320 may also store the review period identified by the content provider A 110A for the item.

In the case of a response received from the user A 120A, the interface 310 may communicate the response to the response processor 320. The response processor 320 may store the response in the data store 245 along with the initial item the response was based on. The response processor 320 may store data describing the user A 120A who provided the response and the date/time the response was provided. In the case of a rating received from the user A 120A, the interface 310 may communicate the rating to the rating processor 330. The rating processor 330 may store the rating in the data store 245 along with the response the rating was given for. The rating processor 330 may also store data describing the user A 120A who provided the rating, data describing the user B 120B who provided the response that was rated, and the date/time the response was rated.

The rating processor 330 may also process storing data when one of the users 120A-N views a response of the user A 120A. The interface 310 may receive an indication that a response of the user A 120A was viewed by the user B 120B and may communicate the indication to the rating processor 330. The rating processor 330 may store data describing the user A 120A who provided the response, data describing the user B 120B who viewed the response, the response viewed, and the date/time the response was viewed.

The rating processor 330 may also process storing the response selected by the content provider A 110A of the most accurate response. The interface 310 may receive an indication of the response selected by the content provider A 110A via the interface 310. The interface 310 may communicate the indication of the selected response to the rating processor 330. The rating processor 330 may store the selected response, data describing the user A 120A who provided the selected response, data describing the content provider A 110A, and the date/time the selected response was received by the interface 310.

The rating calculator 340 may handle calculating the weighted ratings and the total ratings of the responses, and ordering the responses based on their total ratings. The rating calculator 340 may retrieve each rating received for a response and may determine the user A 120A who provided the rating. The rating calculator 340 may then request the user response quality score of the user A 120A who provided the rating from the user response quality score calculator 350. The rating calculator 340 may then determine the weighted rating based on the user response quality score and the value of the rating, such as by multiplying the user response quality score by the value of the rating. Once the rating calculator 340 has determined the weighted ratings, the rating calculator 340 may use the weighted ratings of the response to determine the total rating of the response, such as by taking the average of the weighted ratings of the response. Once the rating calculator 340 has calculated the total rating of each response, the rating calculator 340 may order the responses based on the ratings and may provide the ordered responses, with the total ratings, to the content provider A 110A who provided the initial item.

The service provider 130 may re-calculate a user response quality score of a user A 120A each time the underlying data the score is based on changes. Alternatively or in addition the rating calculator 340 may request the user response quality scores of the users 120A-N when the rating calculator 340 calculates the total rating of each response at the end of review period. The user response quality score calculator 350 may receive a request for the user response quality score of the user A 120A. The user response quality score calculator 350 may use one or more metrics in calculating the user response quality score. The user response quality score calculator 350 may retrieve values from the data store 245 relating to the activity of the user A 120A in the system 100. The values may relate to the number of responses the user A 120A has provided to the system 100, the number of times a response of the user A 120A was viewed by the other users 120B-N, the average rating the responses of the user A 120A received from the users 120B-N, the number of responses of the user A 120A selected by one of the content providers 110A-N, or generally any data that may relate to the proficiency of the user A 120A in the system 100.

The user response quality score calculator 350 may use the values to determine a user response quality score of the user A 120A. For example, the user response quality score calculator 350 may add all of the values together to calculate the user response quality score. Alternatively or in addition different amounts of weight may be given to each of the values before the values are added together. Any of the individual values and/or the final user response quality score may be normalized. Normalizing the values may necessitate determining the average of the metric across all of the users 120A-N, and dividing the value of the user A 120A by the average value of all the users 120A-N.

For example, the user response quality score calculator 350 may determine the number of times the user A 1 20A provided responses to the system 100 and may determine the average number of responses provided by each of the users 120B-N to the system 100. The number of responses provided by the user A 120A may then be divided by the average number of responses provided by the users 120B-N. If the number of responses provided by the user A 120A is higher than the average number of responses then the normalized value will be greater than 1. If the number of response provided by the user A 120A is lower than the average number of responses then the normalized value will be less than one. Normalized values may facilitate using the user response quality scores as weights.

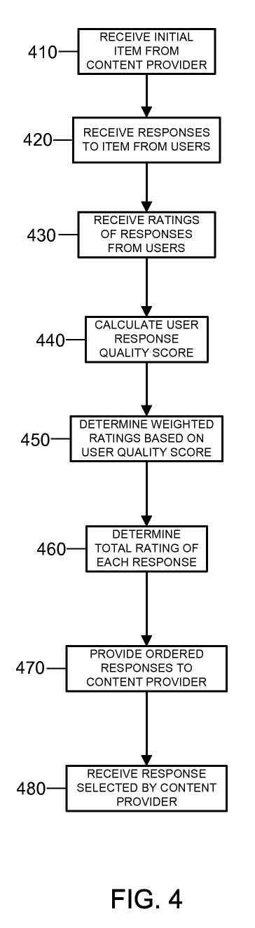

FIG. 4 is a flowchart illustrating the operations of the system of FIG. 1, or other collaborative review systems. At block 410 the service provider 130 may receive an initial item from the content provider A 110A. The content provider A 110A may provide any item which may be commented on, or responded to, such as a question, an image, an audio clip, a news article, or a video. The content provider A 110A may also provide a period of time that the item should be available for review by the users 120A-N, such as one week. Alternatively or in addition the content provider A 110A may select which of the users 120A-N should be able to review the item. The content provider A 110A may only want a subset of the users 120A-N to review the item, such as the users 120A-N who have the highest user response quality scores.

At block 420 the service provider 130 may receive responses from the users 120A-N to the initial item. For example, if the initial item is a question the users 120A-N may respond with answers to the question. At block 430 the system 100 may receive ratings of the responses from the users 120-N. For example, the users 120A-N may provide ratings indicating whether they believe a given response is accurate for the initial item.

At block 440 the review period for the initial item may have ended, and the service provider 130 may calculate the user response quality scores of the users 120A-N who provided ratings. At block 450 the service provider 130 may determine the weighted rating of each rating provided by the users 120A-N. For each rating received, the weighted rating may be calculated by multiplying the user response quality score of the user A 120A who provided the rating by the value of the rating. At block 460 the service provider 130 may determine the total rating of each response based on the weighted ratings of each response. For example the total rating of each response may be calculated by determining the average weighted rating of each response.

At block 470 the service provider 130 may provide the ordered list of responses to the content provider A 110A. The responses may be ordered based on the total ratings of the responses. At block 480 the service provider 130 may receive an indication of the response selected by the content provider A 110A as the most accurate response.

FIG. 5 is a flowchart illustrating the operations of calculating a user response quality score in the system of FIG. 1, or other collaborative review systems. At block 510 the user response quality score calculator 350 may receive a request for a user response quality score, such as from the rating calculator 340. The user response quality score may be requested during the calculation of a weighted score of a user A 120A. At block 520 the service provider 130 may retrieve, from the data store 245, the number of responses the user A 120A provided to the system 100. At block 530 the user response quality score calculator 350 may retrieve, from the data store 245, the number of times the responses of the user A 120A were viewed by other users 120B-N in the system 100. At block 540 the user response quality score calculator 350 may retrieve, from the data store 245, the total rating of each of the responses provided by the user A 120A. The total rating of each of the responses provided by the user A 120A may be used to determine the average total rating of the responses of the user A 120A. At block 550 the user response quality score calculator 350 may retrieve, from the data store 245, the number of responses of the user A 120A selected by one of the content providers 110A-N.

At block 560 the user response quality score calculator 350 may use the retrieved data to calculate the user response quality score of the user A 120A. For example, the user response quality score calculator 350 may determine the normalized value of each of the individual metrics. A normalized value may be determined by calculating the average value of a given metric for all of the users 120A-N, and dividing the value of the user A 120A by the average value of all the users 120A-N. The user response quality score calculator 350 may then add the normalized values of the user A 120A to determine a sum of the normalized values. The sum of the normalized values may be the user response quality score of the user A 120A. Alternatively or in addition, the sum of the normalized values may be normalized to obtain the user response quality score. Alternatively or in addition the user response quality score calculator 350 may add all of the individual values together and normalize the sum of the individual values. Alternatively or in addition the user response quality score calculator 350 may weight one of the values more than the others, such as weighting the average rating of the responses of the user A 120A. Alternatively or in addition the user response quality score may be equal to one of the metrics, such as the number of responses provided by the user A 120A to the system 100.

Alternatively or in addition the user response quality score calculator 350 may calculate a normalized value for each metric by determining the maximum value of the metric for all of the users 120A-N, and dividing the value of the user A 120A by the maximum value of all the users 120A-N. For example, the user response quality score calculator 350 may use three metrics in determining the user response quality score value: the number of responses the user A 120A provided to the system 100, the number of times the responses of the user A 120A were viewed by the users 120A-N, and the average total rating the responses of the user A 120A received in the system 100. The user response quality score calculator 350 may determine the maximum number of responses provided by any of the users 120A-N in the system 100, the maximum number of times responses of any of the users 120A-N were viewed by the other users 120A-N in the system 100, and the maximum average total rating the responses of any of the users 120A-N received in the system 100.

The user response quality score calculator 350 may calculate the normalized value of each of the metrics by dividing the value of the user A 120A by the maximum value in the system 100 for the metric. For example the normalized number of responses provided by the user A 120A may be calculated by dividing the number of responses provided by the user A 120A by the maximum number of responses received by any of the users 120A-N in the system 100. Once the normalized values are determined, the user response quality score calculator 350 may multiply the nominal values by a weight. The weight may be indicative of the importance of the metric to the total rating of the response. For example, the user response quality score calculator 350 may multiply the normalized number of responses by 0.16, the normalized number of views by 0.33, and the normalized average response total rating by 0.5. After multiplying the normalized values by a weight, the user response quality score calculator 350 may add together the results to determine the user response quality score of the user A 120A. At block 570 the user response quality score calculator 350 may provide the user response quality score to the requester, such as the rating calculator 330.

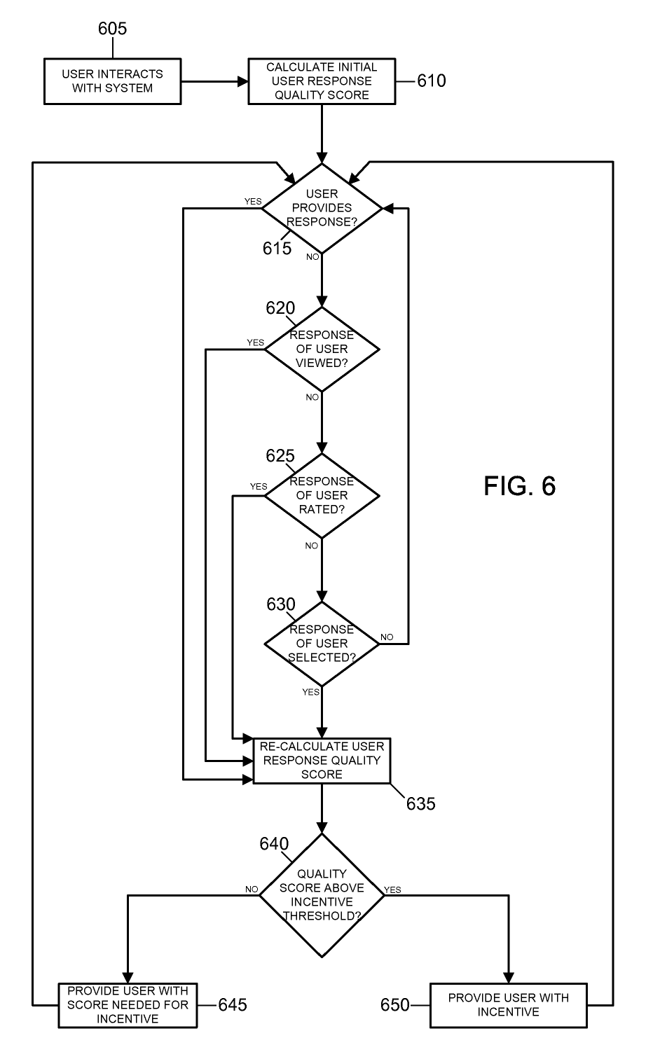

FIG. 6 is a flowchart illustrating the operations of maintaining a user response quality score in the system of FIG. 1, or other collaborative review systems. At block 605 one of the users 120A-N, such as the user A 120A may interact with the system 100 for the first time, such as navigating to web login page of the system 100. The user A 120A may be required to provide information to create an account with the system 100. The information may include personal information, such as name, home address, email address, telephone number, or generally any personal information, demographic information, such as age, ethnicity, gender, or generally any information that may be used in the system 100. The user A 120A may be granted immediate access to the system 100, or an administrator of the system 100 may have to approve of the user A 120A before the user A 120A is granted access to the system 100.

At block 610 the service provider 130 may calculate an initial user response quality score of the user A 120A. The initial user response quality score may be 0, may be a default score, may be a score specified by an administrator with knowledge of the user A 120A, or may be determined based on the information the user A 120A provided to the system 100. At blocks 615-630, the service provider 130 may continually check for updates to the values that the user response quality score may be based on. Alternatively or in addition the user response quality score may only be calculated when a weighted rating of the user A 120A is being determined, or at the end of a review period.

At block 615 the service provider 130 may determine whether the user A 120A provided a response to the system 100. If the user A 120A did not provide a response to the system 100, the system 100 may move to block 620. At block 620 the service provider 130 may determine whether a response of the user A 120A was viewed by one of the other users 120B-N. If a response of the user A 120A was not viewed by one of the other users 120B-N, the system 100 may move to block 625. At block 625 the service provider 130 determines whether a response of the user A 120A was rated by one of the other users 120B-N. If the response of the user A 120A was not rated by one of the other users 120B-N, the system 100 may move to block 630. At block 630 the service provider 130 determines whether a response of the user A 120A was selected by one of the content providers 110A-N as the most accurate response. If a response of the user A 120A was not selected by one of the content providers 110A-N, the system 100 may return to block 615 and continue to check for updates.

If at blocks 615-630 the user A 120A provides a response, or a response of the user A 120A is viewed by one of the other users 120B-N, or a response of the user A 120A is rated by one of the other users 120B-N, or a response of the user A 120A is selected by one of the content providers 110A-N, the system 100 may move to block 635. Alternatively or in addition, if any other values are used to determine the user response quality score, a change to one of those values may cause the system 100 to move to block 635.

At block 635 the service provider 130 may re-calculate the user response quality score of the user A 120A based on the changes in the relevant values. The operations of calculating the user response quality score are discussed in more detail in FIG. 5. At block 640 the service provider 130 may determine whether the re-calculated user response quality score of the user A 120A is above the incentive threshold. If the user response quality score of the user A 120A is above the incentive threshold, the system 100 may move to block 650. At block 650 the service provider 130 may provide the user A 120A with the incentive, such as a gift certificate. The system 100 may then return to block 615 and repeat the checking process. If at block 640 the user response quality score is not above the incentive threshold the system 100 may move to block 645. At block 645 the service provider 130 may notify the user A 120A that their user response quality score has changed, but is still below the incentive threshold. The service provider 130 may provide the user A 120A with the number of points their user response quality score must be raised in order to reach the incentive threshold. The system 100 may then move to block 615 and continue to check for updates.

Alternatively or in addition the service provider 130 may maintain multiple incentive threshold tiers, such as a bronze tier, a silver tier, and a gold tier. The users 120A-N may be rewarded with more valuable incentives when their user response quality score reaches a higher tier. For example, the gold tier may be users 120A-N with a user response quality score in the top ten percent of the users 120A-N, the silver tier may be the top twenty percent and the bronze tier may be the top thirty percent. The gold tier may have the best rewards, while the silver tier may be middle level rewards and the bronze tier may be lower level rewards.

Alternatively or in addition the service provider 130 may maintain a lower user response quality score threshold. If the user response quality score of a user A 120A falls below the lower user response quality score threshold, the user A 120A may be warned that their user response quality score is too low. Alternatively or in addition if the user response quality score of a user A 120A falls below the lower threshold the user A 120A may be removed from the system 100. Alternatively or in addition, in the case of an organization, if the user response quality score of a user A 120A falls below the lower threshold, the user A 120A may be terminated from the organization.

FIG. 7 illustrates a general computer system 700, which may represent a service provider server 240, a third party server 250, the client applications 210A-N, 220A-N, or any of the other computing devices referenced herein. The computer system 700 may include a set of instructions 724 that may be executed to cause the computer system 700 to perform any one or more of the methods or computer based functions disclosed herein. The computer system 700 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 700 may also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions 724 (sequential or otherwise) that specify actions to be taken by that machine. In a particular embodiment, the computer system 700 may be implemented using electronic devices that provide voice, video or data communication. Further, while a single computer system 700 may be illustrated, the term “system” shall also be taken to include any collection of systems or sub-systems that individually or jointly execute a set, or multiple sets, of instructions to perform one or more computer functions.

As illustrated in FIG. 7, the computer system 700 may include a processor 702, such as, a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but may not be limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one case, the memory 704 may include a cache or random access memory for the processor 702. Alternatively or in addition, the memory 704 may be separate from the processor 702, such as a cache memory of a processor, the system memory, or other memory. The memory 704 may be an external storage device or database for storing data. Examples may include a hard drive, compact disc (“CD”), digital video disc (“DVD”), memory card, memory stick, floppy disc, universal serial bus (“USB”) memory device, or any other device operative to store data. The memory 704 may be operable to store instructions 724 executable by the processor 702. The functions, acts or tasks illustrated in the figures or described herein may be performed by the programmed processor 702 executing the instructions 724 stored in the memory 704. The functions, acts or tasks may be independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel processing and the like.

The computer system 700 may further include a display 714, such as a liquid crystal display (LCD), an organic light emitting diode (OLED), a flat panel display, a solid state display, a cathode ray tube (CRT), a projector, a printer or other now known or later developed display device for outputting determined information. The display 714 may act as an interface for the user to see the functioning of the processor 702, or specifically as an interface with the software stored in the memory 704 or in the drive unit 706.

Additionally, the computer system 700 may include an input device 712 configured to allow a user to interact with any of the components of system 700. The input device 712 may be a number pad, a keyboard, or a cursor control device, such as a mouse, or a joystick, touch screen display, remote control or any other device operative to interact with the system 700.

The computer system 700 may also include a disk or optical drive unit 706. The disk drive unit 706 may include a computer-readable medium 722 in which one or more sets of instructions 724, e.g. software, can be embedded. Further, the instructions 724 may perform one or more of the methods or logic as described herein. The instructions 724 may reside completely, or at least partially, within the memory 704 and/or within the processor 702 during execution by the computer system 700. The memory 704 and the processor 702 also may include computer-readable media as discussed above.

The present disclosure contemplates a computer-readable medium 722 that includes instructions 724 or receives and executes instructions 724 responsive to a propagated signal; so that a device connected to a network 235 may communicate voice, video, audio, images or any other data over the network 235. Further, the instructions 724 may be transmitted or received over the network 235 via a communication interface 718. The communication interface 718 may be a part of the processor 702 or may be a separate component. The communication interface 718 may be created in software or may be a physical connection in hardware. The communication interface 718 may be configured to connect with a network 235, external media, the display 714, or any other components in system 700, or combinations thereof. The connection with the network 235 may be a physical connection, such as a wired Ethernet connection or may be established wirelessly as discussed below. Likewise, the additional connections with other components of the system 700 may be physical connections or may be established wirelessly. In the case of a service provider server 240 or the content provider servers 110A-N, the servers may communicate with users 120A-N through the communication interface 718.

The network 235 may include wired networks, wireless networks, or combinations thereof. The wireless network may be a cellular telephone network, an 802.11, 802.16, 802.20, or WiMax network. Further, the network 235 may be a public network, such as the Internet, a private network, such as an intranet, or combinations thereof, and may utilize a variety of networking protocols now available or later developed including, but not limited to TCP/IP based networking protocols.

The computer-readable medium 722 may be a single medium, or the computer-readable medium 722 may be a single medium or multiple media, such as a centralized or distributed database, and/or associated caches and servers that store one or more sets of instructions. The term “computer-readable medium” may also include any medium that may be capable of storing, encoding or carrying a set of instructions for execution by a processor or that may cause a computer system to perform any one or more of the methods or operations disclosed herein.

The computer-readable medium 722 may include a solid-state memory such as a memory card or other package that houses one or more non-volatile read-only memories. The computer-readable medium 722 also may be a random access memory or other volatile re-writable memory. Additionally, the computer-readable medium 722 may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that may be a tangible storage medium. Accordingly, the disclosure may be considered to include any one or more of a computer-readable medium or a distribution medium and other equivalents and successor media, in which data or instructions may be stored.

Alternatively or in addition, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system may encompass software, firmware, and hardware implementations.

The methods described herein may be implemented by software programs executable by a computer system. Further, implementations may include distributed processing, component/object distributed processing, and parallel processing. Alternatively or in addition, virtual computer system processing maybe constructed to implement one or more of the methods or functionality as described herein.

Although components and functions are described that may be implemented in particular embodiments with reference to particular standards and protocols, the components and functions are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

We claim:

1. A method for collaborative review, the method comprising:
receiving a plurality of responses from a plurality of users based on an item provided by a content provider;
receiving a plurality of ratings for each response from the plurality of users;
calculating a user response quality score for each user in the plurality of users;
determining a weighted rating for each rating of each response based on the user response quality score of the user who provided each rating;
determining a total rating for each response based on the weighted ratings of each response; and
providing the responses to the content provider, wherein the responses are ordered in accordance with the total rating of each response.

2. The method of claim 1 wherein the item comprises a question.

3. The method of claim 1 wherein the user response quality score for each user is based on at least one of a number of responses provided by the user, a number of times the plurality of users viewed a response of the user, and an average rating given by the plurality of users to the responses provided by the user.

4. The method of claim 1 further comprising:
selecting, by the content provider, at least one most accurate response in the plurality of responses; and
receiving an indication from the content provider of the at least one best response.

5. The method of claim 4 wherein the user response quality score of each user is based at least in part on a number of times a response provided by the user is selected by the content provider.

6. The method of claim 1 wherein determining a weighted rating of each rating further comprises multiplying the rating by the user quality score of the user who provided the rating.

7. The method of claim 1 wherein the total rating of each response is equal to an average of the weighted ratings of each response.

8. A method for determining the quality of responses of a user in a collaborative environment, the method comprising:
identifying a collaborative environment wherein a user provides a plurality of responses based on a plurality of items provided by a plurality of content providers, and a plurality of users views the plurality of responses and provides a plurality of ratings for the plurality of responses;
determining a quantity of the plurality of responses a user provided to the collaborative environment;
determining a number of times the responses provided by the user were viewed by the plurality of users;
determining an average of the plurality of ratings given by the plurality of users to the responses provided by the user;
calculating a user response quality score based on at least one of the number of responses, the number of times a response was viewed and the average of the plurality of ratings; and
providing the user response quality score to the user.

9. The method of claim 8 further comprising providing an incentive to the user if the user response quality score is higher than a user response quality score threshold.

10. The method of claim 9 wherein the user response quality score threshold represents a user response quality score of a user providing valuable responses to the collaborative network.

11. The method of claim 8 further comprising using the user response quality score to weight the plurality of ratings provided by the user.

12. The method of claim 8 wherein at least one item in the plurality of items comprises a question.

13. The method of claim 8 further comprising:
providing the plurality of responses to a content provider in the plurality of content providers;
receiving from the content provider a selection of at least one most accurate response in the plurality of responses;
determining a number of times the responses provided by the user were selected by one of the content providers; and
calculating the user response quality score based at least in part on the number of times the responses provided by the user were selected by one of the content providers.

14. A system for collaborative review, the system comprising:
means for receiving a plurality of responses from a plurality of users based on an item provided by a content provider;
means for receiving a plurality of ratings for each response from the plurality of users;
means for calculating a user response quality score for each user in the plurality of users;
means for determining a weighted rating for each rating of each response based on the user response quality score of the user who provided each rating;
means for determining a total rating for each response based on the weighted ratings of each response; and
means for providing the responses to the content provider, wherein the responses are ordered in accordance with the total rating of each response.

15. The system of claim 14 wherein the item comprises a question.

16. The system of claim 14 wherein the user response quality score for each user is based on at least one of a number of responses provided by the user, a number of times the plurality of users viewed a response provided by the user, and an average of the plurality of ratings given by the plurality of users to the responses of the user.

17. The system of claim 14 further comprising:
means for selecting, by the content provider, at least most accurate response in the plurality of responses; and
means for receiving an indication from the content provider of the at least one most accurate response.

18. The system of claim 17 wherein the user response quality score of each user is based at least in part on a number of times a response of the user is selected by the content provider.

19. The system of claim 14 wherein the total rating of each response is equal to an average of the weighted ratings of each response.

20. A system for collaborative review, the system comprising:
a memory to store a plurality of responses, an item, a plurality of ratings, a plurality of user response quality scores, a plurality of weighted ratings, and a plurality of total ratings;
an interface operatively connected to the memory, the interface operative to communicate with a plurality of users and a content provider; and
a processor operatively connected to the memory and the interface, the processor operative to receive the item from the content provider via the interface, receive the plurality of responses based on the item from the plurality of users via the interface, receive the plurality of ratings for each response from the plurality of users via the interface, calculate the user response quality score for each user, determine the weighted rating for each rating of each response based on the user quality score of the user who provided each rating, determine the total rating for each response based on the weighted ratings of each response, and provide the responses to the content provider via the interface, the responses ordered in accordance with the total rating of each response.

21. The system of claim 20 wherein the processor is further operative to determine the user response quality score for each user based on at least one of a number of responses provided by the user, a number of times the plurality of users viewed a response provided by the user, and an average rating given by the plurality of users to the responses provided by the user.

22. The system of claim 20 wherein the item comprises a question.

23. The system of claim 20 wherein the processor is further operative to receive a selection from the content provider, via the interface, of at least one most accurate response in the plurality of responses.

24. The system of claim 23 wherein the processor is further operative to determine the user response quality score of each user based at least in part on a number of times a response provided by the user is selected by the content provider.

25. The system of claim 20 wherein the processor is further operative to calculate an average of the weighted ratings of each response, and set the total rating of each response equal to the average of the weighted ratings of each response.
